(19) United States
(12) Patent Application Publication
(10) Pub. No.: US 2008/0244865 A1
(43) Pub. Date: Oct. 9, 2008

(54) Spring hinge for spectacles

(75) Inventor: Harald Buchegger, St. Konrad (AT)

Correspondence Address: COLLARD & ROE, P.C., 1077 NORTHERN BOULEVARD, ROSLYN, NY, 11576, US

(73) Assignee: Redtenbacher Prazisionsteile Ges.m.b.H., Scharnstein (AT)

(21) Appl. No.: 12/079,024

(22) Filed: Mar. 24, 2008

(30) Foreign Application Priority Data
Apr. 3, 2007 (AT) A 519/2007

(51) Int. Cl. G02C 5/22

(52) U.S. Cl. 16/228

(57) ABSTRACT

A spring hinge for spectacles is described having two hinge parts (4, 5) connected to one another in an articulated manner by a hinge axis (7), of which one hinge part (4) is mounted in a hinge housing (1) so it is displaceable against a retracting spring force and the other hinge part (5), which is supported on the hinge housing (1) via a centering, forms at least one stop face (8, 9) working together with the front side of the hinge housing (1) in a stretched position of the hinge parts (4, 5). To achieve guiding of the spectacle earpiece largely without play, it is suggested that the centering provided between the stop face (8, 9) of the one hinge part (5) and the front side of the hinge housing (1) comprise at least one centering groove (10) running around the circumference of the hinge axis (7) and a centering projection (11) engaging in this centering groove (10) at least in the stretched position of the hinge parts (4, 5).

### 1. FIELD OF THE INVENTION

The invention relates to a spring hinge for spectacles having two hinge parts connected in an articulated manner to one another by a spring axis, of which one hinge part is mounted in a hinge housing so it is displaceable against a retracting spring force and the other hinge part, which is supported on the hinge housing via a centering, forms at least one stop face which works together with the front side of the hinge housing in a stretched position of the hinge parts.

### 2. DESCRIPTION OF THE PRIOR ART

Spring hinges for spectacles allow overstretching of the stretch length of the hinge joint predefined by a stop without having to fear damage to the hinge joint and at least secure the stretched position by an elastic stop. Although spring hinges for spectacles are known in various embodiments, all spring hinges share the feature that one of the two hinge parts, which are connected to one another in an articulated manner by a hinge axis, is mounted in a hinge housing so it is displaceable and is impinged by at least one spring in the direction of retraction into the hinge housing. The other hinge part is supported at least in a stretched position of the hinge part via a stop face on the front side of the hinge housing with an elastic pretension, so that the stretched position thus caused is predefined. If the spectacle earpiece is pivoted beyond this stretched position, the hinge part mounted in the hinge housing may be displaced against the force of the spring and release the pivot movement of the earpiece beyond the stop-limited stretched position. To secure not only the stretched position, but rather also the earpiece position pivoted against the spectacle frame, providing a V-shaped recess having an opening angle of 90° in the front side of the hinge housing is known (EP 0 736 790 A1), in which a right-angled projection of the hinge part connected to the spectacle frame may engage in two rotational positions angularly offset by 90°. Independently of whether the spring-loaded support of this hinge part is provided in two pivot positions or only one, a sufficient guide play is necessary for of the hinge part mounted so it is displaceable in the hinge housing, in the scope of which a limited radial displacement capability of the spectacle earpiece results, which is to be avoided as much as possible in the usage position of the earpiece.

In order to support the hinge part belonging to the spectacle frame so it is rotationally fixed in relation to the hinge housing in regard to the axis formed by the displacement guide in the hinge housing, providing projections projecting beyond its front face on the hinge housing, which engage between the two forked hinge lobes of the hinge part belonging to the spectacle frame, is additionally known (WO 03/07 13 38 A1). Because this intervention must also be performed having a certain guide play to ensure the required easiness of the earpiece pivoting, earpiece support in the usage position of the spectacles without play is again not provided.

### SUMMARY OF THE INVENTION

The invention is thus based on the object of designing a spring hinge of the type described at the beginning in such a manner that guiding of the spectacle earpiece largely without play may be ensured, without endangering the easy displaceability of the hinge part mounted in the hinge housing.

The invention achieves the stated object in that the centering provided between the stop face of one hinge part and the front side of the hinge housing comprises at least one centering groove running around the circumference of the hinge axis and a centering projection, which engages in this centering groove at least in the stretched position of the hinge parts.

Through the centering provided between the hinge housing and the hinge part not displaceably mounted in the hinge housing in the form of at least one centering groove running around the circumference of the hinge axis and a centering projection engaging in this centering groove at least in the stretched position of the hinge parts, the two hinge parts are fixed in relation to the hinge housing largely free of play, so that a corresponding guide for the spectacle earpiece which is free of play results. Even with a centering of the earpiece which is only provided in a limited pivot range, secure engagement of the centering projection in a centering groove is ensured. The retracting spring load of the hinge part mounted so it is displaceable in the hinge housing causes elastic pressing of the stop face of the hinge part not mounted in the hinge housing against the housing front side with the effect that the centering projection engages without play in the centering groove, which preferably has a wedge-shaped cross-section, and independently of whether the centering projection belongs to the housing front side or the stop face.

Although the centering projection may fundamentally also be provided on the stop face of one hinge part, more advantageous design conditions result if the centering projection is assigned to the front side of the hinge housing and the centering groove is assigned to the stop face of this hinge part, because the stop face of the hinge part may be provided more easily with a centering groove than with a centering projection, in particular if the centering groove is to extend over the entire pivot angle of the associated hinge part to ensure continuous centering engagement.

For better support of the earpiece in the centering, a centering projection may be provided on the front side of the hinge housing on both sides of a central hinge lobe of the hinge part displaceably guided in the hinge housing, the central hinge lobe forming a centering groove for receiving the centering projections between accommodating hinge lobes of the other hinge part in the area of the stop faces, so that an earpiece centering occurs on both sides of the central hinge lobe of the spring hinge.

### BRIEF DESCRIPTION OF THE DRAWING

The object of the invention is illustrated as an example in the drawing.

FIG. 1 shows a spring hinge of a pair of spectacles according to the invention in a simplified side view,

FIG. 2 shows this spring hinge in a top view,

FIG. 3 shows a section along line III-III of FIG. 1,

FIG. 4 shows an illustration of a design variant of a spring hinge according to the invention corresponding to FIG. 1,

FIG. 5 shows the spring hinge from FIG. 4 in a top view, and

FIG. 6 shows the spring hinge from FIGS. 4 and 5 in detail in the area of the centering in a section along line VI-VI of FIG. 4 in an enlarged scale.

### DESCRIPTION OF THE PREFERRED EMBODIMENT

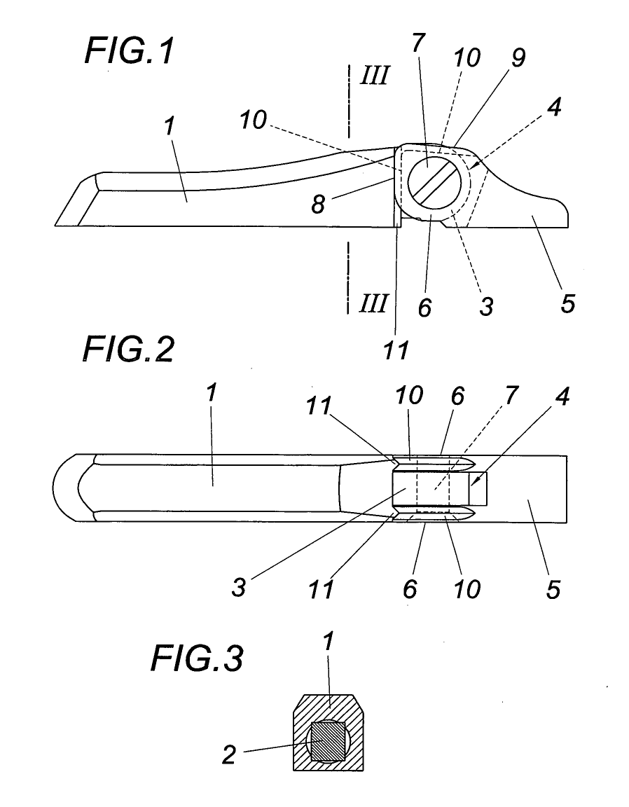

The spring hinge according to FIGS. 1 through 3 typically has a hinge housing 1 connectable to a spectacle earpiece, in which a sliding part 2 of a hinge part 3 forming a central hinge lobe 4 is displaceably guided. This sliding part 2 is impinged with the aid of a spring in the direction of an insertion of the hinge part 4 into the hinge housing 1.

The hinge part 5 connectable to a spectacle cheek has two hinge lobes 6 enclosing the central hinge lobe 3 on both sides. The hinge axis, which penetrates the hinge lobes 3 and 6 in the form of a screw, is identified by 7. The hinge part 5 assigned to the spectacle cheek forms two stop faces 8 and 9, which work together with the front side of the hinge housing 1 and on one hand fixes the stretched position of the hinge parts 4, 5 and thus the stretched position of the earpiece shown in the drawing and on the other hand fixes an earpiece position folded in against the spectacle frame, because the stop faces 8, 9 are pressed against the front side of the hinge housing 1 by the spring impinging the sliding part 2 in the particular pivot position of the hinge joint.

The elastic pressing of the stop faces 8 and 9 against the housing front side may advantageously be used for guiding the earpiece without play. For this purpose, a centering is provided between the front side of the hinge housing 1 and the stop faces 8, 9, which is formed on one hand by at least one centering groove 10, which is wedge-shaped in cross-section, and is formed on the other hand by a centering projection 11 engaging in the centering groove 10. According to the exemplary embodiment from FIGS. 1 through 3, each of the two hinge lobes 6 of the hinge part 5 has a centering groove 10 extending over both stop faces 8, 9, while corresponding centering projections 11 in the form of hinge strips are provided on the front side of the hinge housing 1, which run like the centering grooves 10 around the circumference in relation to the hinge axis 7, so that the hinge part 5 is fixed without play in relation to the hinge housing 1 in the direction of the hinge axis 7, because the centering projections 11 are pressed into the centering grooves 10 as a result of the retracting spring load of the hinge part 4. Because the centering grooves 10 and the centering projections 11 run around the circumference, the ability of the jointed hinge to pivot is not impaired by the centering, which is active over the entire pivot range of the jointed hinge as a result of the continuous engagement of the centering projections 11 in the centering grooves 10.

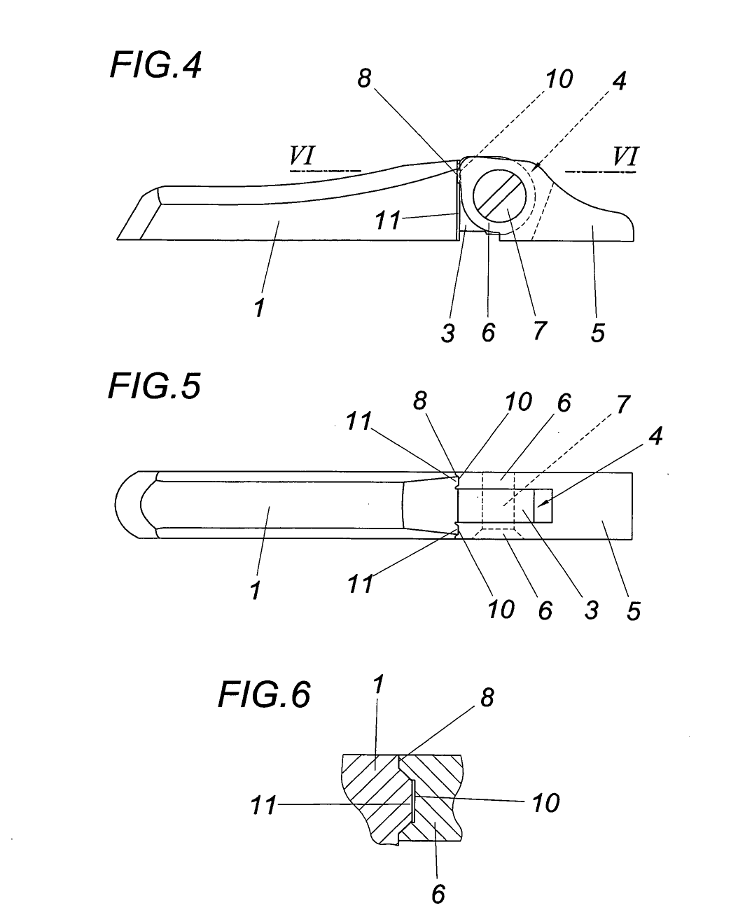

The spring hinge according to the embodiment from FIGS. 4 through 6 differs from that from FIGS. 1 through 3 essentially only in the type of the centering, because the centering is only active between the stop face 8 of the hinge part 5 for the stretched position of the hinge joint and the front face of the hinge housing 1. The centering grooves 10 are provided in the area of the stop face 8, which only extends over a partial area of the front side of the hinge housing 1. This means that the earpiece connected to the hinge housing 1 is held without play only in the stretched position, i.e., in its usage position, which is sufficient for the usage of the spectacles, however.

1. A spring hinge for spectacles having two hinge parts connected in an articulated manner to one another by a hinge axis, of which one hinge part is mounted in a hinge housing so it is displaceable against a retracting spring forest and the other hinge part, which is supported on the hinge housing via a centering, forms at least one stop face working together in a stretched position of the hinge parts with the front side of the hinge housing, wherein the centering provided between the stop face (8, 9) of one hinge part (5) and the front side of the hinge housing (1) comprises at least one centering groove (10) running around the circumference of the hinge axis (7) and a centering projection (11) engaging in this centering groove (10) at least in the stretched position of the hinge parts (4, 5).

2. The spring hinge according to claim 1, wherein the centering projection (11) is assigned to the front side of the hinge housing (1) and the centering groove (10) is assigned to the stop face (8, 9) of the one hinge part (5).

3. The spring hinge according to claim 2, wherein the centering groove (10) extends over the entire pivot angle of the associated hinge part (5).

4. The spring hinge according to claim 1, wherein a centering projection (11) is provided on the front side of the hinge housing (1) on both sides of a central hinge lobe (3) of the hinge part (4) displaceably guided in the hinge housing (1), and the central hinge lobe (3) forms a centering groove (10) for receiving the centering projections (11) between each of receiving hinge lobes (6) of the other hinge part (5) in the area of its stop faces (8, 9).
